(19) United States
(12) Patent Application Publication
(10) Pub. No.: US 2015/0002247 A1
(43) Pub. Date: Jan. 1, 2015

(54) ELECTRO-MAGNETIC CONTACTOR

(71) Applicant: LSIS CO., LTD., Anyang-si (KR)

(72) Inventor: Dong Chae RHO, Cheongju-si (KR)

(73) Assignee: LSIS CO., LTD., Anyang-si (KR)

(21) Appl. No.: 14/293,991

(22) Filed: Jun. 2, 2014

(30) Foreign Application Priority Data
Jul. 1, 2013 (KR) 10-2013-0076579

(51) Int. Cl. H01H 1/64

(52) U.S. Cl. CPC H01H 1/64
USPC 335/133

(57) ABSTRACT

An electromagnetic contactor according to an embodiment of the present disclosure may include a lower frame; a fixed core provided to be inserted into the lower frame; a bobbin provided at an upper portion of the fixed core; a coil coupled to the bobbin; a movable core provided at an upper portion of the bobbin; a cross bar coupled to an upper portion of the movable core; a movable contact coupled to the cross bar to move in an upward and downward direction; an upper frame configured to cover the lower frame; and a fixed contact fixed to part of the upper frame, wherein a protection base is formed to be protruded from an intermediate portion of the fixed contact.

### CROSS-REFERENCE TO RELATED APPLICATIONS

Pursuant to 35 U.S.C. §119(a), this application claims the benefit of earlier filing date and right of priority to Korean Patent Application No. 10-2013-0076579, filed on Jul. 1, 2013, the contents of which are all hereby incorporated by reference herein in its entirety.

### BACKGROUND OF THE INVENTION

1. Field of the Invention

The present invention relates to an electromagnetic contactor, and more particularly, an electromagnetic contactor provided with a fixed contact formed with a protection base stably fixed to prevent the inflow of foreign substances and reduce vibration, thereby reducing the contamination of a fixed contact point as well as reducing a conduction failure rate.

2. Description of the Related Art

In general, electromagnetic contactor is a type of electrical circuit switching device for transferring a mechanical drive and current signal using the principle of an electromagnet, and provided in various industrial facilities, machines, vehicles, and the like.

First, the outline of the configuration and operation of an electromagnetic contactor according to the related art will be described. FIG. 1 is an internal perspective view illustrating an electromagnetic contactor according to the related art, and FIG. 2 is a partial cross-sectional view illustrating an electromagnetic contactor according to the related art, and FIG. 3 is a front view illustrating a fixed contact of the electromagnetic contactor according to the related art.

According to an electromagnetic contactor in the related art, the external appearance of an electromagnetic contactor is formed by an upper and a lower frame 1, 2, and a plurality of fixed contact 3 connected to the power input side or load side terminal of an electrical circuit, respectively, are provided at the upper frame 1.

Furthermore, a bobbin coil 4 generating a magnetic force according to the application of power is provided at a lower portion of an internal space formed between the upper and the lower frame 1, 2, and a fixed core 5 magnetized according to the magnetic force generation of the bobbin coil 4 is provided at a lower portion of the bobbin coil 4, and a movable core 6 performing an up-and-down movement according to the magnetic force generation and extinction is provided at an upper portion of the fixed core 5. A return spring 7 providing a restoring force to the movable core 6 is provided between the bobbin coil 4 and the movable core 6.

In addition, a cross bar 8 performing an up-and-down movement along with the movable core 6 is provided at an upper portion of the movable core 6, and a movable contact 9 electrically connected or short-circuited to the each fixed contact 3 is provided at the cross bar 8.

In an electromagnetic contactor having the foregoing configuration, when a current is applied to the bobbin coil 4, the fixed core 5 provided at a lower portion thereof is magnetized as energizing the bobbin coil 4. The movable core 6 provided over an upper portion of the fixed core 5 moves downward to the fixed core 5 due to an attractive force by the magnetic force of the magnetized fixed core 5, and the cross bar 8 coupled to the movable core 6 moves downward at the same time.

Accordingly, the movable contact 9 coupled to the cross bar 8 is connected to the fixed contact 3 fixed and provided at the upper frame 1.

On the contrary, when the magnetic force of the bobbin coil 4 becomes extinct, an attraction force for pulling the movable core 6 disappears, and the movable core 6 is separated from the fixed core 5 by a restoring force of the return spring 7 and moved upward to an original location.

However, according to such an electromagnetic contactor in the related art, foreign substances may adhere to a contact surface between the fixed contact 3 and the movable contact 9 due to foreign substances such as dust or the like coming through the opening portion 10. When foreign substances adhere to a contact surface between the fixed contact 3 and the movable contact 9, an electromagnetic force is weakened and it occurs a phenomenon in which the fixed contact 3 and the movable contact 9 cannot be properly brought into contact with each other, thereby increasing a conduction failure rate due to this. Furthermore, the fixed contact 3 may be turned over during a component transport process or the like even in the fabrication process, thereby causing foreign substances to be adhered to the contact surface.

As a technology proposed to solve the above-mentioned problems, a contact mounting structure in an electromagnetic contactor has been disclosed in Korean Patent Registration No. 10-0518256. According to the above invention, an orientation between a movable contact 60 and a fixed contact 80 is disposed perpendicular to an orientation between a movable contact 16 and a fixed contact 15, thereby preventing a contact failure phenomenon and an abnormal noise phenomenon due to dust generation. However, even in the above invention, it may be impossible to prevent dust from flowing in through the opening portion of a grid, and difficult to cope with the adhesion of foreign substances generated during the fabrication process or the like.

### SUMMARY OF THE INVENTION

The present invention is contrived to solve the foregoing problems, and an aspect of the present invention is to provide an electromagnetic contactor provided with a fixed contact formed with a protection base stably fixed to prevent the inflow of foreign substances and reduce vibration, thereby reducing the contamination of a fixed contact point as well as reducing a conduction failure rate.

An electromagnetic contactor according to an embodiment of the present disclosure may include a lower frame; a fixed core provided to be inserted into the lower frame; a bobbin provided at an upper portion of the fixed core; a coil coupled to the bobbin; a movable core provided at an upper portion of the bobbin; a cross bar coupled to an upper portion of the movable core; a movable contact coupled to the cross bar to move in an upward and downward direction; an upper frame configured to cover the lower frame; and a fixed contact fixed to part of the upper frame, wherein a protection base is formed to be protruded from an intermediate portion of the fixed contact.

Here, the transverse cross-sectional area of the protection base may be formed in a circular shape.

Furthermore, the diameter of the protection base may be formed to be less than the width of the fixed contact.

Furthermore, the protection base may be brought into contact with an inner partition wall of the upper frame.

According to an electromagnetic contactor in accordance with an embodiment of the present disclosure, a protection base may be formed at a fixed contact, thereby having an effect of reducing the contamination phenomenon of the fixed contact point. In other words, even when an operation is carried out while the fixed contact is turned over during the fabrication process, a protection base at a higher position than that of the fixed contact point may be first brought into contact with the bottom, thereby preventing foreign substances from being adhered to the fixed contact. Furthermore, the inflow of foreign substances may be suppressed while being used, thereby having an effect of reducing the amount of external foreign substances from flowing therein.

Furthermore, the vibration of the fixed contact may be reduced due to the protection base being brought into contact with an inner partition wall, thereby having an effect of stably fixing the fixed contact.

On the other hand, a conduction failure rate may be reduced due to the above-mentioned effects.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

In the drawings:

FIG. 1 is an internal perspective view illustrating an electromagnetic contactor in the related art;

FIG. 2 is a partial perspective view illustrating an electromagnetic contactor according to the related art;

FIG. 3 is a front view illustrating a fixed contact of the electromagnetic contactor according to the related art;

FIG. 4 is an internal perspective view illustrating an electromagnetic contactor according to the present disclosure;

FIG. 5 is a perspective view illustrating a fixed contact of the electromagnetic contactor;

FIGS. 6a and 6b are a plan view and a front view illustrating a fixed contact of the electromagnetic contactor in FIG. 5; and

FIG. 7 is a partial perspective view illustrating an electromagnetic contactor according to the present disclosure.

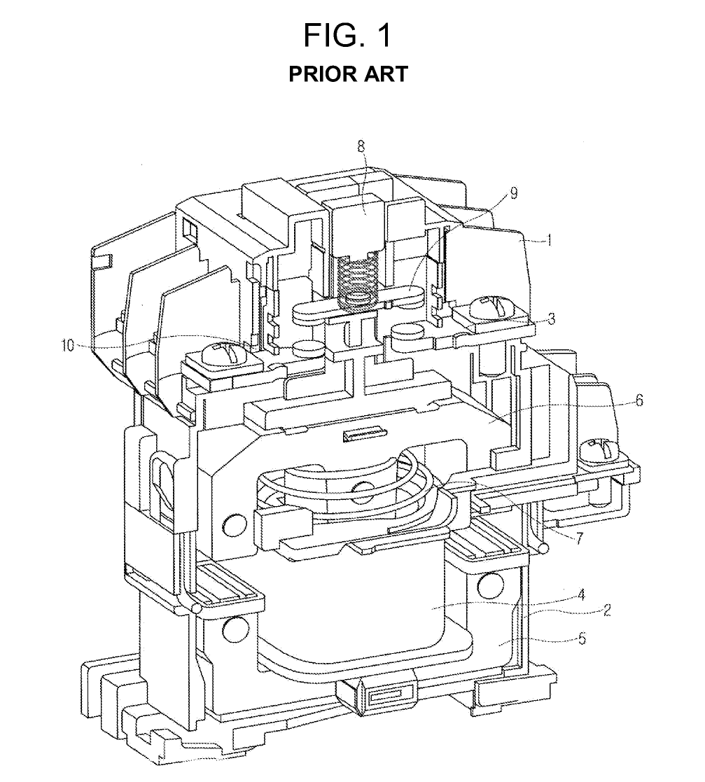

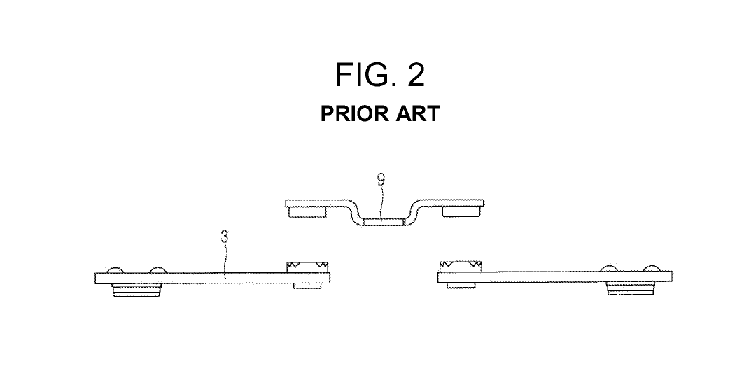

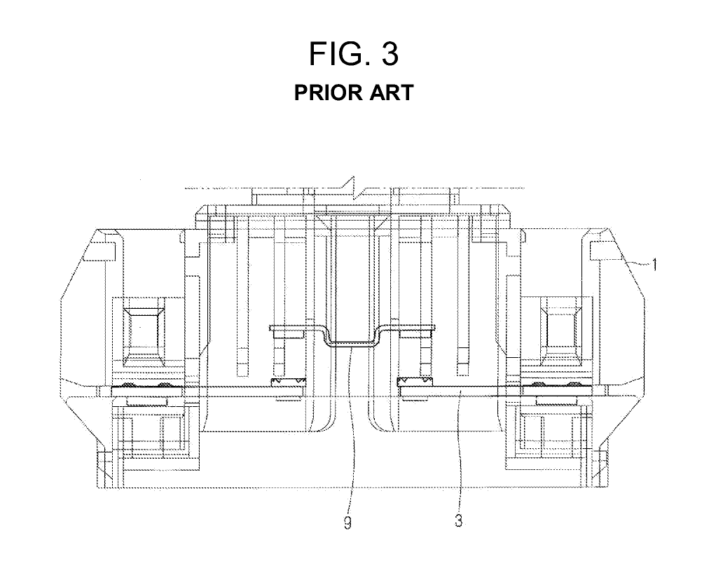

### DETAILED DESCRIPTION OF THE INVENTION

Hereinafter, a preferred embodiment of the present invention will be described in detail with reference to the accompanying drawings to such an extent that the present invention can be easily implemented by a person having ordinary skill in the art to which the present invention pertains, but it does not mean that the technical concept and scope of the present invention are limited due to this.

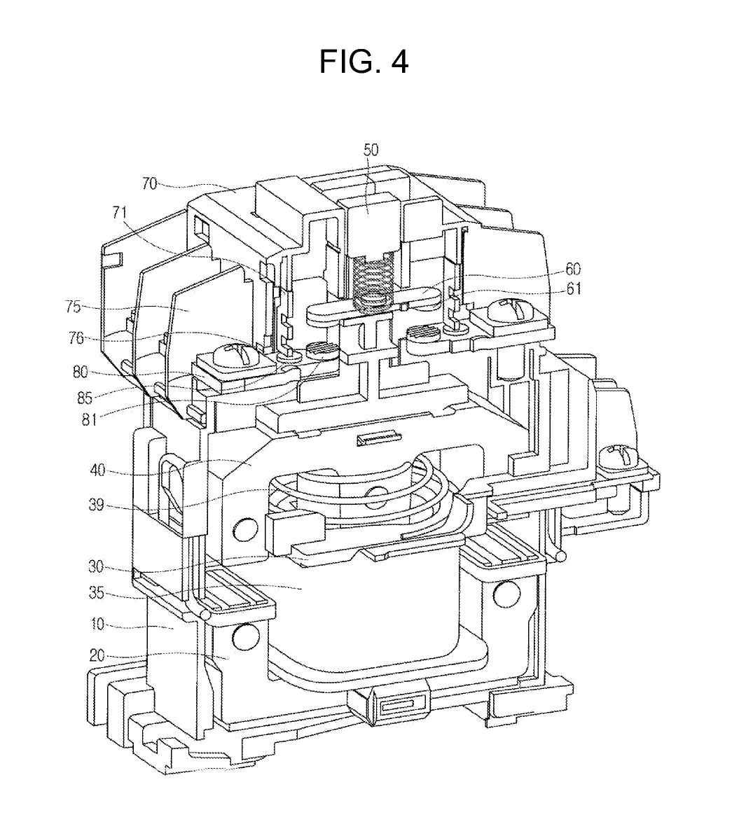

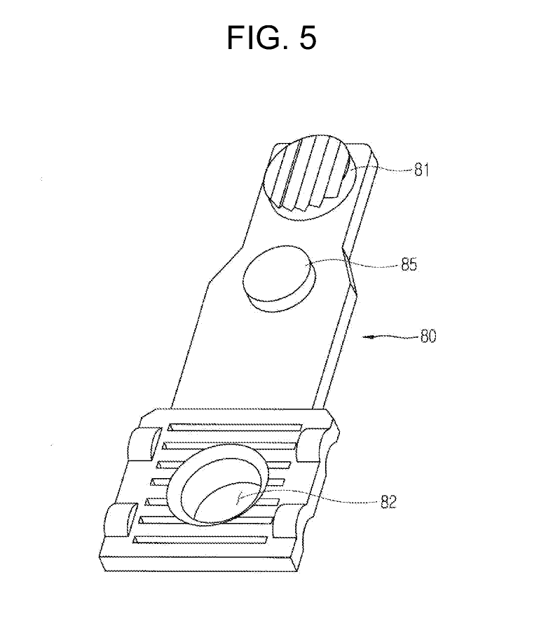

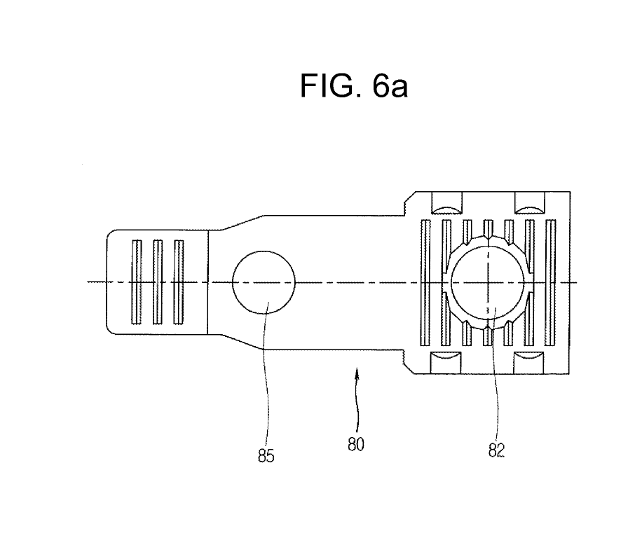

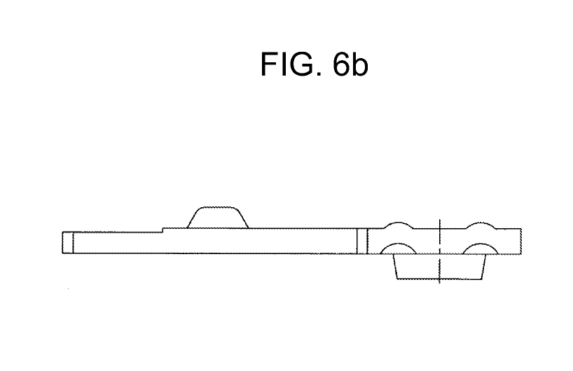

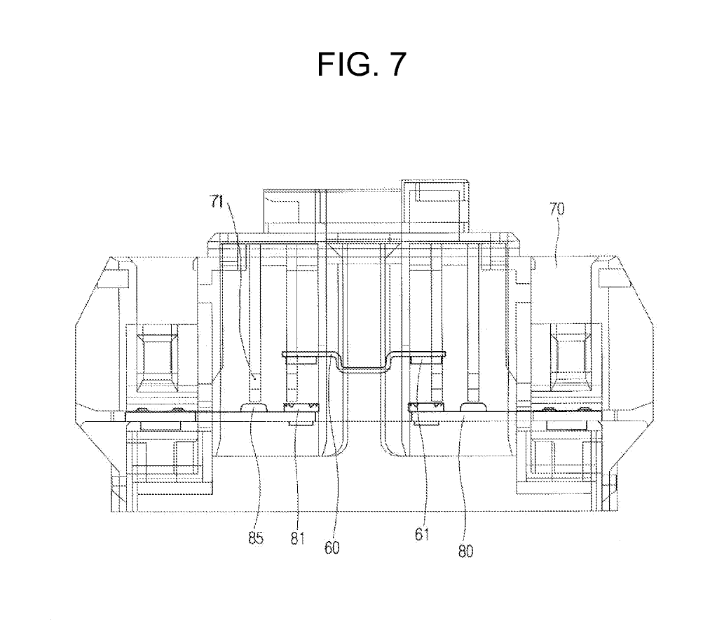

FIG. 4 is an internal perspective view illustrating an electromagnetic contactor according to the present disclosure, and FIG. 5 is a perspective view illustrating a fixed contact of the electromagnetic contactor according to the present disclosure, and FIGS. 6a and 6b are a plan view and a front view of FIG. 5, and FIG. 7 is a partial perspective view illustrating an electromagnetic contactor according to the present disclosure. An embodiment of the present disclosure will be described in detail with reference to the drawings.

An electromagnetic contactor according to an embodiment of the present disclosure may include a lower frame 10; a fixed core 20 provided to be inserted into the lower frame 10; a bobbin 30 provided at an upper portion of the fixed core 20; a coil 35 coupled to the bobbin 30; a movable core 40 provided at an upper portion of the bobbin 30; a cross bar 50 coupled to an upper portion of the movable core 40; a movable contact 60 coupled to the cross bar 50 to move in an upward and downward direction; an upper frame 70 configured to cover the lower frame 10; and a fixed contact 80 fixed to part of the upper frame 10. Here, it is characterized in that a protection base 85 is formed at an intermediate portion of the fixed contact 80.

The lower frame 10 is formed in a rectangular shape as a whole, and an upper surface thereof is open to form an accommodation space therein. The bobbin 30 and coil 35 are provided at a central portion of the lower frame 10.

The fixed core 20 is coupled to an inner bottom of the lower frame 10. The fixed core 20 is magnetized according to the flow of current to have a magnetic force.

The coil 35 is wound around the bobbin 30, and the bobbin 30 is fixed and coupled to one side of the lower frame 10. When a current flows through the coil 35 coupled to the bobbin 30, a magnetic force is formed at the fixed core 20.

The bobbin 30 may include an upper plate, a lower plate and a coil accommodation portion, and a return spring 39 is provided on the upper plate of the bobbin 30.

The movable core 40 is provided at an upper portion of the bobbin 30, and moves downward by the magnetic force of the fixed core 20. When the movable core 40 moves downward, an elastic force is stored in the return spring 39, and the stored elastic force is released as a restoring force to move the movable core 40 in an upward direction to an original location when the magnetic force of the fixed core 20 becomes extinct.

The cross bar 50 is coupled to an upper portion of the movable core 40 to move upward along with the movable core 40. The cross bar 50 is coupled to the movable contact 60 and connected to the fixed contact 80 according to the downward movement of the movable core 40.

The fixed contact 80 is provided to be brought into contact with or separated from the movable contact 60 at a portion adjacent to the movable contact 60 on both sides of the upper frame 70. A fixed contact point 81 is formed at one side upper portion of the fixed contact 80, and a screw hole 82 is formed at the other side thereof. The fixed contact point 81 may be formed with a plurality of embossings along the length direction to facilitate the fixed contact point 81 to be separated from the movable contact point 61. The protection base 85 is formed to be protruded from an intermediate portion of the fixed contact 80 to prevent foreign substances from flowing in from the outside. The transverse cross-sectional area of the protection base 85 may be formed in a circular shape to minimize foreign substances from being brought into contact therewith. Preferably, the protection base 85 is stably formed in a truncated conical shape.

Due to the formation of the protection base 85, foreign substances cannot easily flow therein from the outside through an opening portion 76 of the grid 75 of the upper frame 70. Furthermore, even when the fixed contact 80 is turned over during a component transport process or the like even in the fabrication process, the protection base 85 is brought into contact with the bottom but the fixed contact point 81 is not brought into contact with the bottom, thereby disallowing foreign substances to be adhered to the fixed contact point 81. The contamination of the fixed contact point 81 may be reduced to decrease the possibility of causing a conduction failure.

Furthermore, an upper surface of the protection base 85 may be formed to be brought into contact with an inner partition wall 71 of the upper frame 70. Since the upper surface of the protection base 85 is brought into contact with the inner partition wall 71 of the upper frame 70, the vibration of the fixed contact 80 is restricted, thereby maintaining a state of being stably fixed and coupled to the upper frame 70 with no vibration. Accordingly, contact and separation between the fixed contact 80 and the movable contact 60 may be stably carried out, thereby stably operating the electromagnetic contactor.

The fixed contact 80 and the movable contact 60 may be operated while being stably brought into contact with or separated from each other, thereby having an effect of reducing a conduction failure rate of the electromagnetic contactor.

On the other hand, furthermore, the diameter of the protection base 85 may be formed to be less than the width of the fixed contact 80. Accordingly, even when the protection base 85 is brought into contact with the inner partition wall 71 of the upper frame 70, a space is formed around the protection base 85, thereby forming a space capable of discharging an arc generated during the process of separating the fixed contact 80 from the movable contact 60.

Although the present invention has been described with reference to the foregoing preferred embodiments, it will be easily recognized by those skilled in the art that various modifications and changes can be made without departing from the gist and scope of the invention, and it should be also clearly understood that all these modifications and changes fall in the appended claims.

What is claimed is:

1. An electromagnetic contactor, comprising:
a lower frame;
a fixed core provided to be inserted into the lower frame;
a bobbin provided at an upper portion of the fixed core;
a coil coupled to the bobbin;
a movable core provided at an upper portion of the bobbin;
a cross bar coupled to an upper portion of the movable core;
a movable contact coupled to the cross bar to move in an upward and downward direction;
an upper frame configured to cover the lower frame; and
a fixed contact fixed to part of the upper frame,
wherein a protection base is formed to be protruded from an intermediate portion of the fixed contact.

2. The electromagnetic contactor of claim 1, wherein the transverse cross-sectional area of the protection base is formed in a circular shape.

3. The electromagnetic contactor of claim 2, wherein the diameter of the protection base is formed to be less than the width of the fixed contact.

4. The electromagnetic contactor of claim 1, wherein the protection base is brought into contact with an inner partition wall of the upper frame.
